(19) United States
(12) Patent Application Publication
(10) Pub. No.: US 2012/0163164 A1
(43) Pub. Date: Jun. 28, 2012

(54) METHOD AND SYSTEM FOR REMOTE LOAD BALANCING IN HIGH-AVAILABILITY NETWORKS

(75) Inventors: John Michael Terry, San Jose, CA (US); Mandar Joshi, Pleasanton, CA (US); Phanidhar Koganti, Sunnyvale, CA (US); Shunjia Yu, San Jose, CA (US); Anoop Ghanwani, Rocklin, CA (US)

(73) Assignee: BROCADE COMMUNICATIONS SYSTEMS, INC., San Jose, CA (US)

(21) Appl. No.: 13/092,873

(22) Filed: Apr. 22, 2011

Related U.S. Application Data
(60) Provisional application No. 61/427,437, filed on Dec. 27, 2010.

(51) Int. Cl. H04L 12/56; H04L 12/26

(52) U.S. Cl. 370/221; 370/392; 370/235

(57) ABSTRACT

A system is provided for facilitating remote load balancing in a high-availability network. During operation, the system receives a plurality of data frames destined for a destination device, wherein the destination device is coupled to a network via a trunk link, the trunk link coupling the destination device to at least two separate egress switching devices. The system then forwards the data frames via at least two data paths, each of which leads to a respective egress switching device.

### RELATED APPLICATIONS

This application claims the benefit of U.S. Provisional Application No. 61/427,437, Attorney Docket Number BRCD-3056.0.1.US.PSP, entitled “Method and System for Remote Load Balancing in High-Availability Networks,” by inventors John Michael Terry, Mandar Joshi, Phanidhar Koganti, and Shunjia Yu, and Anoop Ghanwani, filed 27 Dec. 2010, the disclosure of which is incorporated by reference herein.

The present disclosure is related to U.S. patent application Ser. No. 12/725,249, (attorney docket number BRCD-112-0439US), entitled “REDUNDANT HOST CONNECTION IN A ROUTED NETWORK,” by inventors Somesh Gupta, Anoop Ghanwani, Phanidhar Koganti, and Shunjia Yu, filed 16 Mar. 2010; and

U.S. patent application Ser. No. 13/087,239, (attorney docket number BRCD-3008.1.US.NP), entitled “VIRTUAL CLUSTER SWITCHING,” by inventors Suresh Vobbilisetty and Dilip Chatwani, filed 14 Apr. 2011;

the disclosures of which are incorporated by reference herein.

### BACKGROUND

1. Field

The present disclosure relates to network management. More specifically, the present disclosure relates to a method and system for remote load balancing in high-availability networks.

2. Related Art

Currently, end stations in layer-2 networks have not been able to take advantage of the routing functionalities available in such networks. End stations can typically only operate as leaf nodes and are often constrained to an interface with only one of the routing nodes. Even when an end station is interfaced with two or more routing nodes, other routing nodes in the network can send data to that end station only via one routing node to which the end station is connected.

Meanwhile, layer-2 networking technologies continue to evolve. More routing functionalities, which have traditionally been the characteristics of layer-3 (e.g., IP) networks, are migrating to layer-2. Notably, the recent development of the Transparent Interconnection of Lots of Links (TRILL) protocol allows Ethernet switches to function more like routing nodes. TRILL overcomes the inherent inefficiency of the conventional spanning tree protocol, which forces layer-2 switches to be coupled in a logical spanning-tree topology to avoid looping. TRILL allows routing bridges (RBridges) to be coupled in an arbitrary topology without the risk of looping by implementing routing functions in switches and including a hop count in the TRILL header.

However, there is currently no support of remote load balancing on data paths leading to a destination device coupled to at least two separate egress switching devices in a TRILL network.

### SUMMARY

One embodiment of the present invention provides a system for facilitating remote load balancing in a high-availability network. During operation, the system receives a plurality of data frames destined for a destination device, wherein the destination device is coupled to a network via a trunk link, the trunk link coupling the destination device to at least two separate egress switching devices. The system then forwards the data frames via at least two data paths, each of which leads to a respective egress switching device.

In a variation on this embodiment, the system forwards a data frame via a respective data path by placing a respective egress switching device's identifier in the header of the frame.

In a variation on this embodiment, the switching devices are routing bridges capable of routing data frames without requiring the network topology to be a spanning tree topology.

In a variation on this embodiment, the trunk link is associated with a virtual identifier.

In a further variation, the virtual identifier is a virtual routing bridge identifier based on the TRILL protocol.

In a variation on this embodiment, the system selects a respective data path based on a hash value computed on at least one field in the data frame header, thereby achieving load balancing among the different data paths.

In a variation on this embodiment, the system selects a respective data path based on a predetermined load distribution, thereby achieving load balancing among the different switched paths.

In a variation on this embodiment, the system selects next-hop switching devices corresponding to different data paths for forwarding the data frames, thereby achieving load balancing among the different data paths.

In a variation on this embodiment, in response to detecting a failure of a link between the destination device and an egress switching device, the system advertises non-reachability to that egress switching device.

### BRIEF DESCRIPTION OF THE FIGURES

FIG. 1 illustrates an exemplary network that facilitates virtual RBridge identifier assignment to a host coupled to multiple TRILL RBridges via link aggregation, in accordance with an embodiment of the present invention.

FIG. 2 presents a flowchart illustrating the process of remote load balancing in a TRILL network, in accordance with an embodiment of the present invention.

FIG. 3 illustrates an exemplary header configuration of an ingress TRILL frame, in accordance with an embodiment of the present invention.

FIG. 4 illustrates exemplary hierarchical load balancing using a hash method on various header fields, in accordance with an embodiment of the present invention.

FIG. 5 presents a flowchart illustrating the process of selecting a data path based on various header fields, in accordance with an embodiment of the present invention.

FIG. 6 illustrates a scenario where one of the physical links of a link aggregation coupled to a host experiences a failure, in accordance with an embodiment of the present invention.

FIG. 7 presents a flowchart illustrating the process of handling a link failure that affects a host which is assigned a virtual RBridge ID, in accordance with an embodiment of the present invention.

FIG. 8 illustrates an exemplary architecture of a switch that facilitates remote node balancing in a TRILL network, in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

### Overview

In embodiments of the present invention, the problem of remote load balancing on data paths leading to a destination host which is coupled to at least two separate egress RBridges in a TRILL network is solved by replacing the destination's virtual RBridge ID with a respective egress RBridge ID in the header of the data frame. The data frames are thus forwarded to the destination host via at least two data paths, each of which leads to a respective egress RBridge.

For example, in a layer-2 network running the TRILL protocol, when a host is coupled to one or more routing bridges (RBridges), a virtual TRILL RBridge identifier is assigned to this host. The host is then considered to be a virtual RBridge capable of running the TRILL protocol. The assignment of a virtual RBridge identifier allows a non-TRILL-capable host to participate in the routing domain of a TRILL network, and to be coupled to multiple RBridges in an arbitrary topology. Such a configuration provides tremendous flexibility and facilitates high availability in case of both link and node failures. For instance, an end station with a virtual RBridge identifier can be coupled to two or more physical RBridges using link aggregation. The physical RBridges can advertise connectivity to the virtual RBridge to their neighbor RBridges. Consequently, other RBridges in the TRILL network can reach this host through multiple data paths by specifying any respective physical RBridge IDs coupled to the virtual RBridge as egress points. Moreover, when one of the aggregated links fails, the affected end station can continue operating via the remaining link(s). For the rest of the TRILL network, the host with a virtual RBridge ID remains reachable.

Although this disclosure is presented using examples based on the TRILL protocol, embodiments of the present invention are not limited to TRILL networks, or networks defined in a particular Open System Interconnection Reference Model (OSI reference model) layer. In particular, although the term “layer-2” is mentioned several times in the examples, embodiments of the present invention are not limited to application to layer-2 networks. Other networking environments, either defined in OSI layers or other layering models, or not defined with any layering model, can also use the disclosed embodiments. For instance, these embodiments can apply to Multiprotocol Label Switching (MPLS) networks as well as Storage Area Networks (e.g., Fibre Channel networks).

Furthermore, although intermediate-system-to-intermediate-system (IS-IS) routing protocol is used in the TRILL examples, embodiments of the present invention are not limited to a particular routing protocol. Other routing protocols, such as Open Shortest Path First (OSPF), Routing Information Protocol (RIP), Interior Gateway Routing Protocol (IGRP), Enhanced IGRP (EIGRP), Border Gateway Protocol (BGP), or other open or proprietary protocols can also be used. In addition, embodiments of the present invention are not limited to the TRILL frame encapsulation format. Other open or proprietary encapsulation formats and methods can also be used.

The term “RBridge” refers to routing bridges, which are bridges implementing the TRILL protocol as described in IETF draft “RBridges: Base Protocol Specification,” available at http://tools.ietf.org/html/draft-ietf-trill-rbridge-protocol-14, which is incorporated by reference herein. Embodiments of the present invention are not limited to application among RBridges. Other types of switches, routers, and forwarders can also be used.

The term “physical RBridge” refers to an RBridge running TRILL protocol, as opposed to a “virtual RBridge,” which refers to a non-TRILL end station with a virtual RBridge ID.

The term “virtual RBridge” refers to a non-TRILL end station with a virtual RBridge ID. The physical RBridge(s) to which the non-TRILL end station is coupled can advertise the connectivity to this end station as if it were a regular RBridge.

The term “multi-homed host” refers to a host that has an aggregate link to two or more TRILL RBridges, where the aggregate link includes multiple physical links to the different RBridges. The aggregate link functions as one logical link to the host. “Multi-homed host” may also refer to a host coupled to TRILL RBridges which do not form a logical link aggregation and do not form an association with each other. This could be the case where a host has multiple logical networking entities (an example is a virtualized server where different servers may be coupled to different networks through different network ports in the system). A single host can have multiple virtual RBridge identifier assignments.

The term “frame” refers to a group of bits that can be transported together across a network. “Frame” should not be interpreted as limiting embodiments of the present invention to layer-2 networks. “Frame” can be replaced by other terminologies referring to a group of bits, such as “packet,” “cell,” or “datagram.”

The term “RBridge identifier” refers to a group of bits that can be used to identify an RBridge. Note that the TRILL standard uses “RBridge ID” to denote the 48-bit intermediate-system-to-intermediate-system (IS-IS) System ID assigned to an RBridge, and “RBridge nickname” to denote the 16-bit value that serves as an abbreviation for the “RBridge ID.” The “RBridge identifier” used in this disclosure is not limited to any bit format, and can refer to “RBridge ID,” “RBridge nickname,” or any other format that can identify an RBridge.

### Network Architecture

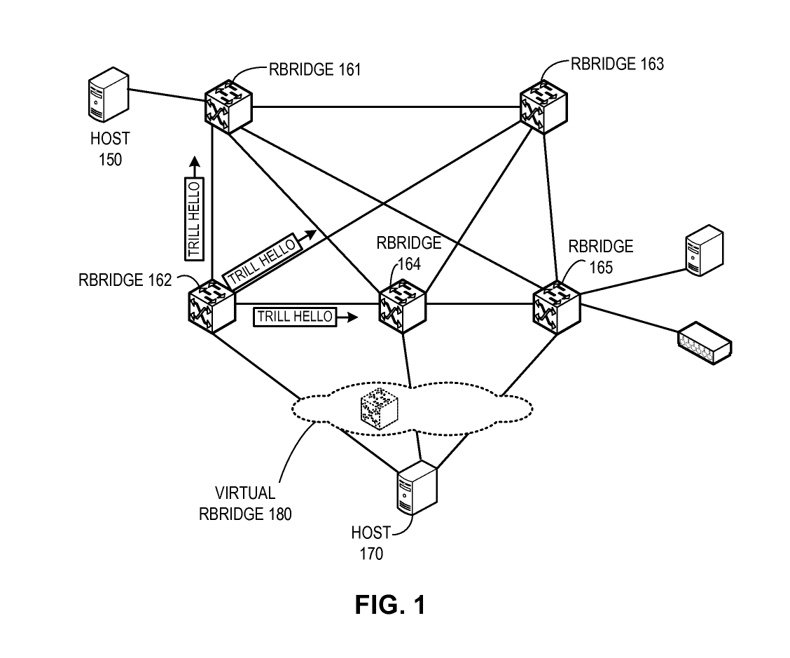

FIG. 1 illustrates an exemplary network that facilitates virtual RBridge identifier assignment to a host coupled to multiple TRILL RBridges via link aggregation, in accordance with an embodiment of the present invention. This configuration allows the host to be part of the routed TRILL network, and thus take advantage of the topology flexibility. In the example, the TRILL network includes five physical RBridges: 161, 162, 163, 164, and 165. A host 170 is multi-homed with three physical RBridges 162, 164, and 165. During operation, a virtual RBridge 180 is associated with host 170, either manually or automatically, by one of the coupled physical RBridges using Link Layer Discovery Protocol (LLDP) or any other configuration/discovery protocol. The neighbor RBridges (162, 164, and 165) broadcast their connectivity with virtual RBridge 180 so that the rest of the TRILL network can view virtual RBridge 180 just like any other RBridge and route traffic toward it via any available path.

Without virtual RBridge identifier assignment, host 170 would be “transparent” to the rest of the TRILL network. The frames sent from host 170 to the TRILL network are native Ethernet frames. An RBridge in the TRILL network would associate the Media Access Control (MAC) addresses for host 170 with an ingress RBridge (i.e., the first RBridge in the TRILL network that receives these Ethernet frames). In addition, without virtual RBridge identifier assignment, the multi-homing-style connectivity would not provide the desired result, because the TRILL protocol depends on MAC address learning to determine the location of end stations (i.e., to which ingress RBridge an end station is coupled) based on a frame's ingress TRILL RBridge ID. As such, a host can only appear to be reachable via a single physical RBridge. For example, assume that host 150 is in communication with host 170. When RBridge 161 receives frames from host 170 and performs MAC address learning, RBridge 161 would assume that the host is coupled to one of RBridges 162, 164, or 165. Consequently, only one of the physical links leading to host 170 is used for subsequent traffic from host 160 to host 170.

Host 170 has its links to RBridges 162, 164, and 165 configured as a link aggregation (LAG). In other words, host 170 can distribute ingress traffic entering the TRILL network among the three links using link aggregation techniques. Such techniques can include any multi-chassis trunking techniques. In addition, RBridges 162, 164, and 165 are configured to process ingress frames from host 170 such that these frames will have the virtual RBridge nickname in their TRILL header as the ingress RBridge. When these frames are forwarded to the rest of the TRILL network with their respective TRILL headers, other RBridges in the network treat them as originating from virtual RBridge 180.

During operation, each physical RBridge sends TRILL HELLO messages to its neighbor to confirm its health. Each RBridge also sends link state protocol data units (LSPs) to its neighbor, so that link state information can be exchanged and propagated throughout the TRILL network. As illustrated in FIG. 1, RBridge 162 regularly transmits TRILL HELLO messages to its neighboring RBridges 161, 163, and 164. In addition, RBridge 162 has a static link state entry for virtual RBridge 180 associated with host 170, and periodically announces the reachability to this virtual RBridge in its LSPs to other RBridges. Similarly, RBridges 164 and 165 also maintain static link state entries for virtual RBridge 180 and announce its reachability in their respective LSPs.

More details on multi-homed end stations and virtual RBridges can be found in U.S. application Ser. No. 12/725,249, filed 16 Mar. 2009, entitled “Redundant Host Connection in a Routed Network,” by inventors Somesh Gupta, Anoop Ghanwani, Phanidhar Koganti, and Shunjia Yu (Attorney Docket number BRCD-112-0439.US.NP) and U.S. application Ser. No. 12/730,749, filed 24 Mar. 2010, entitled “Method and System for Extending Routing Domain to Non-routing End Stations,” by inventors Pankaj K. Jha and Mitri Halabi (Attorney Docket number BRCD-3009.US.NP), the disclosures of which are incorporated by reference herein.

### Remote Load Balancing

Load balancing at layer 2 traffic to be spread among multiple layer-2 data paths. In embodiments of the present invention, remote load balancing allows traffic sharing among multiple egress devices to which a destination host is coupled. For example, in the TRILL network shown in FIG. 1, host 150 communicates with host 170 which is coupled to RBridges 162, 164, and 165. Frames from host 150 to host 170 can be forwarded by any one of three RBridges 162, 164, and 165 or distributed among them. Remote load balancing allows host 150 to distribute frames among three data paths available through RBridges 162, 164, and 165 when it sends frames to host 170. Based on the virtual RBridge ID 180 associated with host 170, host 150 maintains three equal-cost paths and selects one of these three physical RBridges as the egress RBridge for a frame. The selection can be made using a round-robin scheme or a hash method based on the frame headers. Once the physical egress RBridge is chosen, host 150 determines the next-hop RBridge corresponding to the selected egress RBridge. For example, host 150 selects RBridge 164 as the egress and then chooses to forward frames to RBridge 161.

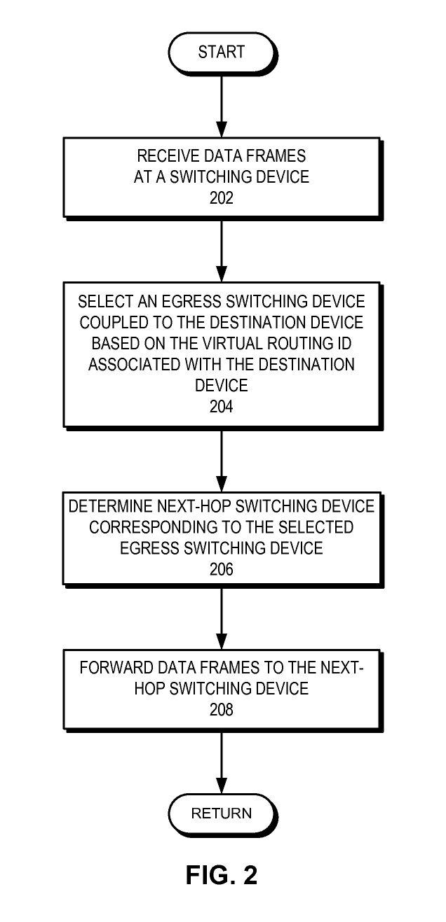

FIG. 2 presents a flowchart illustrating the process of remote load balancing in a TRILL network, in accordance with an embodiment of the present invention. During operation, an RBridge participating in remote load balancing receives ingress Ethernet frames destined to a host configured with a virtual RBridge ID for its LAG (operation 202). The RBridge then selects a physical egress RBridge coupled to the destination host based on the virtual RBridge ID associated with the host (operation 204). Next, the RBridge determines the next-hop RBridge based on the physical egress RBridge nickname selected (operation 206). It is assumed that the routing function in the TRILL protocol or other routing protocol is responsible for populating the forwarding information base at each RBridge. In addition, the information on the association between a virtual RBridge and the corresponding physical egress RBridges (such as virtual RBridge 180 and physical RBridges 162, 164, and 165 in FIG. 1) is also distributed by the routing function. The RBridge then forwards the frames to the next-hop RBridge (operation 208).

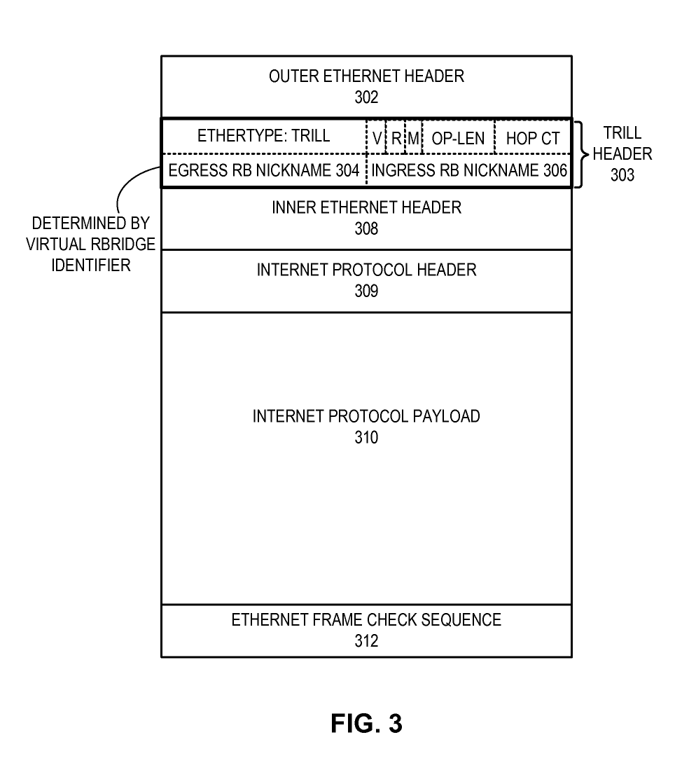

FIG. 3 illustrates an exemplary header configuration of an ingress TRILL frame, in accordance with an embodiment of the present invention. In this example, a TRILL-encapsulated frame includes an outer Ethernet header 302, a TRILL header 303, an inner Ethernet header 308, an IP header 309, an IP payload 310, and an Ethernet frame check sequence (FCS) 312. TRILL header 303 includes a version field (denoted as “V”), a reserved field (denoted as “R”), a multi-destination indication field (denoted as “M”), an option-field-length indication field (denoted as “OP-LEN”), and a hop-count field (denoted as “HOP CT”). Also included are an egress RBridge nickname field 304 and an ingress RBridge nickname field 306.

In the above example illustrated in FIG. 1 where host 150 communicates with host 170, inner Ethernet header 308 contains the original source and destination MAC addresses for the communicating hosts. The MAC address of host 150 is set as the source MAC address in the inner Ethernet header, and the MAC address of host 170 is set as the destination MAC address in the inner Ethernet header. The destination MAC address is used to determine the egress RBridge, which in this case is virtual RBridge 180. Subsequently, the RBridges 162, 164, and 165 are identified as the physical egress RBridges based on their association with virtual RBridge 180. Correspondingly, the nickname of one of the physical egress RBridges, which is selected based on a load balancing policy, is placed in egress Rbridge nickname field 304. The MAC address of the next-hop RBridge is then determined and placed in the destination MAC address in the outer Ethernet header, and the MAC address of the local transmitting RBridge is the source MAC address in the outer Ethernet header. After setting the outer Ethernet header, the TRILL-encapsulated frames are transmitted to the next-hop RBridge.

### Hash Method

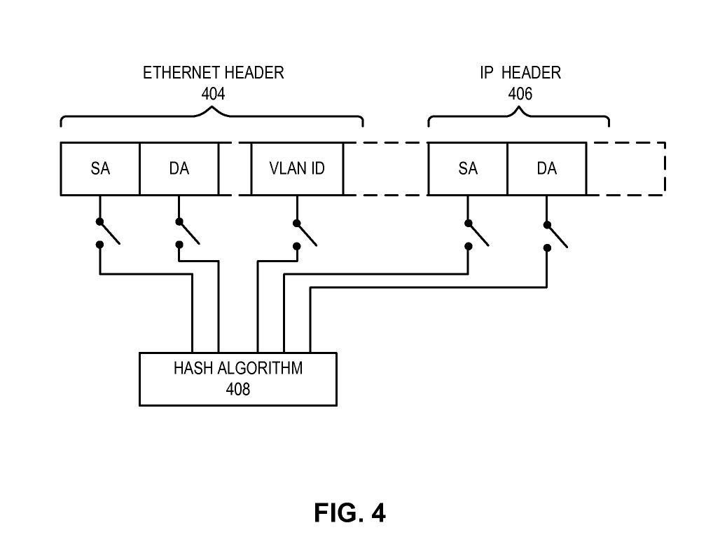

Load balancing can be achieved by frame distribution policies. A simple example is a round-robin policy where, for each incoming frame destined to a multi-homed end station, a different egress RBridge is selected, so that frames are spread evenly across all links. Frame distribution policies can also rely on a hash method: it computes a hash value of certain fields in the frame header based on a load balancing configuration. Hash-based load balancing ensures that data path selections are consistent even when the list of available egress switching device is modified in the network. FIG. 4 illustrates an exemplary hierarchical load balancing scheme using a hash method on various header fields, in accordance with an embodiment of the present invention. The hash algorithm 408 can take one or a combination of various fields from different headers, such source address, destination address, and VLAN tag in an Ethernet header, source address and destination address in IP header 406, and port numbers in transport layer (e.g., TCP or UDP) headers (not shown). The output of hash algorithm 408 is then used to determine which physical egress RBridge (and correspondingly the data path) is to be used to forward the traffic. For example, certain Ethernet traffic with a given VLAN tag can be forwarded to a given physical egress RBridge. Packets with the same destination MAC address but a different VLAN tag can be forwarded to a different physical egress RBridge. This flexibility can facilitate a variety of load balancing schemes based on requirements on different layers. Note that, although the hashing method is described here, other load balancing schemes, such as round robin, or transport-layer port number-based scheme, can also be used.

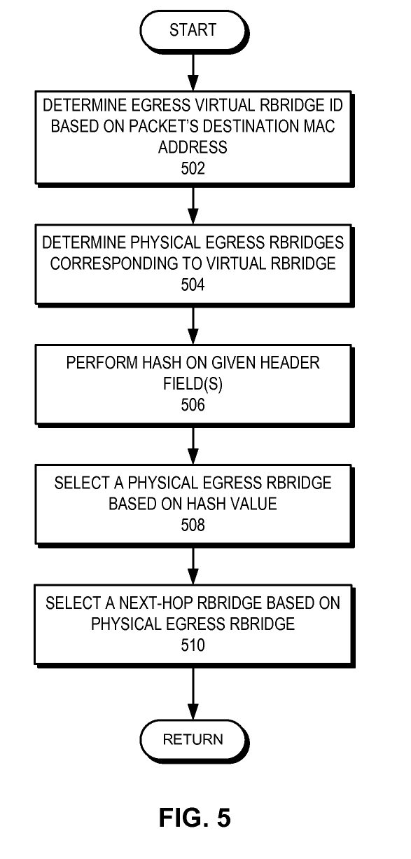

FIG. 5 presents a flowchart illustrating the process of selecting a data path based on various header fields, in accordance with an embodiment of the present invention. After an ingress physical RBridge determines the physical egress RBridges for an ingress Ethernet packet, it can perform load balancing using the hash method. During operation, the RBridge first determines the egress virtual RBridge ID based on the incoming Ethernet packet's destination MAC address (operation 502). The RBridge then determines the physical egress RBridges corresponding to the virtual RBridge (operation 504). Subsequently, a hash is performed on given header field(s) in the incoming packet (operation 506). The RBridge then selects one of the determined physical egress Bridges based on the hash value (operation 508). Next, the next-hop Bridge is selected based on the physical egress Bridge (operation 510). Note that different physical egress RBridge may result in different next-hop RBridges, because each physical egress RBridge corresponds to a different data path.

### Failure Handling

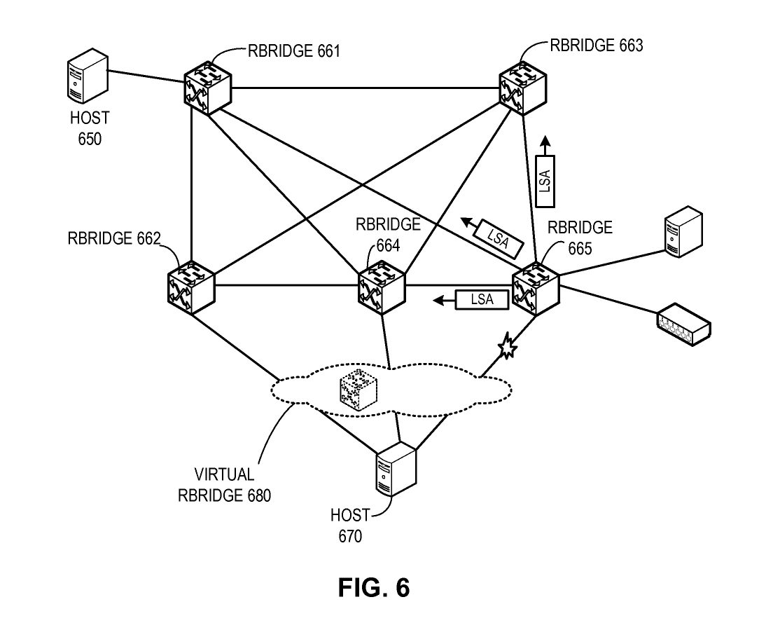

One advantage of assigning a virtual RBridge identifier to a non-TRILL switch is to facilitate connectivity across multiple physical RBridges, which in turn provides protection against both link and node failures. FIG. 6 illustrates a scenario where one of the physical links of a link aggregation coupled to a non-TRILL node experiences a failure, in accordance with an embodiment of the present invention. In this example, a host 670 is coupled to three physical RBridges 662, 664, and 665 via link aggregation. Host 670 is assigned a virtual RBridge ID 680. Suppose the link between host 670 and RBridge 665 fails. As a result, RBridge 665 will notify its neighbor RBridges about the non-reachability of host 670. Meanwhile, the virtual RBridge 180 remains effective with RBridges 662 and 664, which can still be used for determining the egress RBridge nickname in the TRILL headers of frames for remote load balancing.

RBridge 665 may still receive some frames destined to host 670 before the TRILL network topology converges. Since RBridges 662 and 664 can both be used to reach host 670, RBridge 665 can forward these frames to RBridge 662 or 664. Thus, minimum service interruption can be achieved during link failure. Similarly, in the case of node failure (e.g., when RBridge 665 fails), host 670 can continue operation with virtual RBridge 180. Furthermore, RBridge 665 disassociates itself with virtual RBridge 680. The routing function distributes an update to the virtual RBridge-to-physical RBridge mapping information, so that virtual RBridge 680 is only associated with physical RBridges 662 and 664.

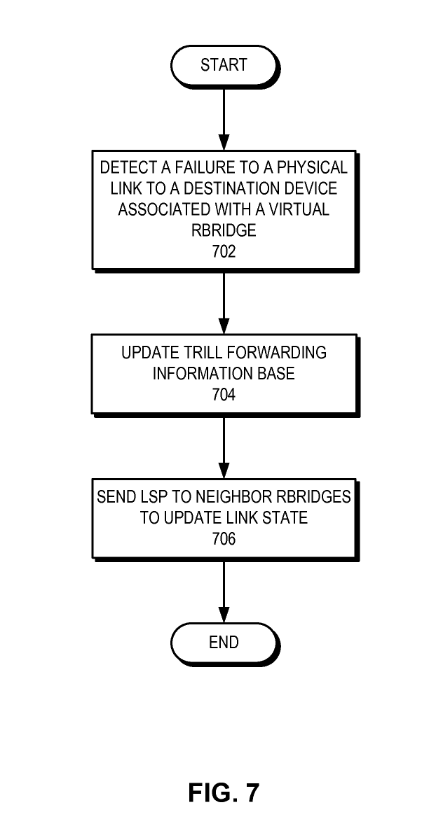

FIG. 7 presents a flowchart illustrating the process of handling a link failure that affects a host which is assigned a virtual RBridge ID, in accordance with an embodiment of the present invention. During operation, a physical RBridge detects a failure of a physical link to a host associated with the virtual RBridge (operation 702). The physical RBridge then updates its TRILL forwarding information base to reflect this topology change (704). This update also includes the disassociation of itself with the virtual RBridge. Subsequently, the RBridge sends link state protocol data units (LSPs) to its neighbor RBridges to update the link state (operation 706). Note that the host corresponding to the virtual RBridge identifier does not need to be re-configured. It only needs to re-distribute the outgoing frames to the remaining links within the LAG coupling to other physical RBridges.

### Exemplary Switch System

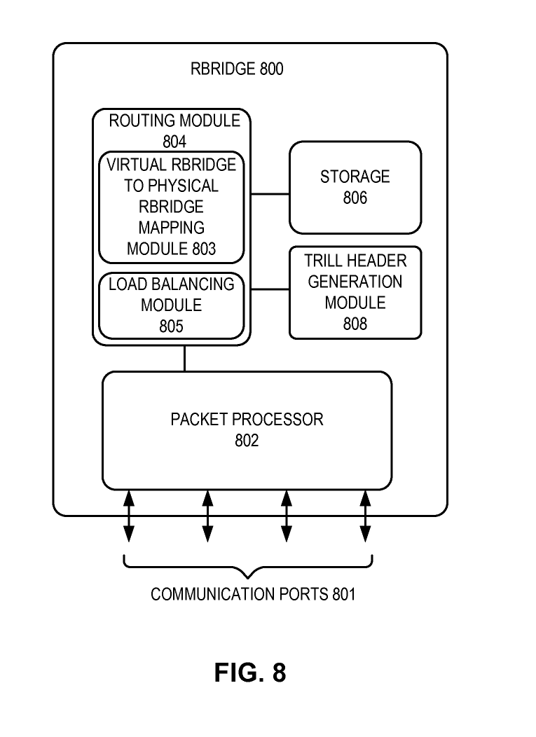

FIG. 8 illustrates an exemplary architecture of a switch that facilitates remote load balancing in a TRILL network, in accordance with an embodiment of the present invention. In this example, RBridge 800 includes a number of communication ports 801, a packet processor 802, a routing module 804, a virtual RBridge to physical RBridge mapping module 803, a load balancing module 805, a storage device 806, and a TRILL header generation module 808. During operation, communication ports 801 receive frames from (and transmit frames to) the end stations. Packet processor 802 extracts and processes the header information from the received frames. Note that communication ports 801 include at least one inter-switch port for communication with one or more RBridges participating in a link aggregation. Routing module 804 performs a routing lookup based on an incoming packet's destination MAC address to determine the virtual egress RBridge. Virtual RBridge to physical RBridge mapping module 803 determines the physical egress RBridges corresponding to a virtual egress RBridge. Load balancing module 805 selects one of the physical egress RBridges as the destination RBridge for the packet using, for example, a hash-based load balancing method. The routing tables and virtual RBridge to physical RBridge mapping information is stored in storage 806. TRILL header generation module 808 generates the proper TRILL header for a packet before it forwards the TRILL encapsulated packet to the next-hop RBridge.

In summary, embodiments of the present invention provide a method and system for facilitating load balancing in a high-availability network. In one embodiment, a virtual RBridge is formed to accommodate an aggregate link from a host to multiple physical RBridges. Data frames are forwarded to the host via at least two data paths, each of which leads to a respective egress RBridge coupled to the host. Such a configuration provides a scalable and flexible solution to remote load balancing in a TRILL network.

The methods and processes described herein can be embodied as code and/or data, which can be stored in a computer-readable non-transitory storage medium. When a computer system reads and executes the code and/or data stored on the computer-readable non-transitory storage medium, the computer system performs the methods and processes embodied as data structures and code and stored within the medium.

The methods and processes described herein can be executed by and/or included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of embodiments of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A system, comprising:
a receiving mechanism configured to receive a plurality of data frames destined for a destination device, wherein the destination device is coupled to a network via at least two separate egress switching devices; and
a forwarding mechanism configured to forward the data frames via at least two data paths, each of which leads to a respective egress switching device.

2. The system of claim 1, further comprising a header generation mechanism configured to place a respective egress switching device's identifier corresponding to a data path in the header of a frame.

3. The system of claim 1, wherein the switching devices are routing bridges capable of routing data frames without requiring the network topology to be a spanning tree topology.

4. The system of claim 1, wherein the destination device is coupled to the egress switching devices via a trunk link which is associated with a virtual identifier.

5. The system of claim 4, wherein the virtual identifier is a virtual routing bridge identifier based on the TRILL protocol.

6. The system of claim 4, further comprising a routing mechanism configured to disassociate the egress switching device from the virtual identifier in response to a failure of a link between the destination device and an egress switching device.

7. The system of claim 1, further comprising a load balancing mechanism configured to select a respective data path based on a hash value computed on at least one field in the data frame header, thereby achieving load balancing among the different data paths.

8. The system of claim 1, further comprising a load balancing mechanism configured to select a respective data path based on a predetermined load distribution.

9. The system of claim 1, wherein the forwarding mechanism is further configured to select next-hop switching devices corresponding to different data paths for forwarding the data frames.

10. A method comprising:
receiving a plurality of data frames destined for a destination device, wherein the destination device is coupled to a network via at least two separate egress switching devices; and
forwarding the data frames via at least two data paths, each of which leads to a respective egress switching device.

11. The method of claim 10, wherein forwarding a data frame via a respective data path comprises placing a respective egress switching device's identifier corresponding to a data path in the header of a frame.

12. The method of claim 10, wherein the switching devices are routing bridges capable of routing data frames without requiring the network topology to be a spanning tree topology.

13. The method of claim 10, wherein the destination device is coupled to the egress switching devices via a trunk link which is associated with a virtual identifier.

14. The method of claim 13, wherein the virtual identifier is a virtual routing bridge identifier based on the TRILL protocol.

15. The method of claim 13, wherein in response to a failure of a link between the destination device and an egress switching device, the method further comprises disassociating the egress switching device from the virtual identifier.

16. The method of claim 10, further comprising selecting a respective data path based on a hash value computed on at least one field in the data frame header, thereby achieving load balancing among the different data paths.

17. The method of claim 10, further comprising selecting a respective data path based on a predetermined load distribution.

18. The method of claim 10, further comprising selecting next-hop switching devices corresponding to different data paths for forwarding the data frames.

19. A switch means, comprising:
a receiving means for receiving a plurality of data frames destined for a destination device, wherein the destination device is coupled to a network via at least two separate egress switching devices; and
a forwarding means for forwarding the data frames via at least two data paths, each of which leads to a respective egress switching device.

20. The switch means of claim 19, further comprising a header generation means for placing a respective egress switching device's identifier corresponding to a data path in the header of a frame.

21. The switch means of claim 19, further comprising a load balancing means for selecting a respective data path based on a hash value computed on at least one field in the data frame header, thereby achieving load balancing among the different data paths.
